(19) United States
(12) Patent Application Publication
(10) Pub. No.: US 2005/0229766 A1
(43) Pub. Date: Oct. 20, 2005

(54) Punching apparatus having detachable handle device

(76) Inventor: Pei-Yuan Lee, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 11/153,645

(22) Filed: Jun. 15, 2005

Related U.S. Application Data
(62) Division of application No. 10/761,713, filed on Jan. 21, 2004.

(30) Foreign Application Priority Data
Sep. 19, 2003 (TW) 92126019

(51) Int. Cl. B26D 1/12; B26F 1/14

(52) U.S. Cl. 83/669; 83/684

(57) ABSTRACT

A punching apparatus includes a base, a punching structure, a transmitting shaft and a handle member. The base is used for placing thereon an object to be punched. The punching structure is mounted over the base for digging into the object to create at least one hole. The transmitting shaft is coupled to the punching structure and rotated to actuate the punching structure to move between a punching position and a releasing position in response to first and second external forces, respectively. The handle member is attachable to and detachable from any of a first end and a second end of the transmitting shaft, and transmits the punching structure to move between the punching position and the releasing position in response to the first and the second external forces exerted thereon, respectively.

### CROSS-REFERENCE TO RELATED APPLICATION

This application is a division of U.S. application Ser. No. 10/761,713, filed Jan. 21, 2004, which application is incorporated by reference.

### FIELD OF THE INVENTION

The present invention relates to a punching apparatus, and more particularly to a punching apparatus having a detachable handle device.

### BACKGROUND OF THE INVENTION

A punching apparatus is widely used to punch holes in an edge margin of a stack of paper sheets to be filed. Referring to FIGS. 1(a) and 1(b), two kinds of conventional punching apparatus are shown. Each of the punching apparatus 1 and 2 comprises a base 10, a handle 11 and a punching structure inside the casing 12. The punching structure principally comprises a plurality of punchers (not shown), which dig into the paper sheets to create a corresponding number of through holes in response to the user's downward pushing force exerted on the handle 11. The principle and operation of the punching structure are well known in the art and need not be further described in detail herein. For punching holes, the paper sheets are firstly placed on a top surface of the base 10 with a front thereof sustaining against the alignment wall 100 under the punching structure. The pushing force applied onto the handle 11 pivots the handle 11 so as to transmit the plurality of punchers to move downward and dig into the paper sheets, thereby punching holes on the paper sheets.

The handle 11 of the punching apparatus 1 shown in FIG. 1(a) is disposed on the right side P1 of the punching structure (casing 12) in order to comply with the requirement of right-hand users. On the other hand, the handle 11 of the punching apparatus 2 shown in FIG. 1(b) is disposed on the left side P2 of the casing 12 for complying with the requirement of left-hand users. For a user habituating the left hand, the use of the punching apparatus 1 is difficult because the user could not manipulate the handle smoothly and conveniently.

In order to match the postures of both the right-hand and left-hand users, another two kinds of punching apparatus are shown in FIGS. 2(a) and 2(b) and described hereinafter. In FIG. 2(a), the punching apparatus 3 has two handles 11 disposed on both sides P1 and P2 of the punching structure (casing 12). Alternatively, as shown in FIG. 2(b), a U-shape handle 13 is used in lieu of the separate handles 11. The punching apparatus 3 or 4 is convenient for both the right-hand and left-hand users to use. However, the presence of the dual handles 11 or the handle 13 hinders the paper sheets from positioning on the base 10. Also, a relatively large space will be required for packing the punching apparatus. Moreover, the additional handle 11 or the enlarged handle 13 increases the cost for producing the punching apparatus due to the increase of material and the complexity of assembling.

### SUMMARY OF THE INVENTION

It is an object of the present invention to provide a punching apparatus having a handle device optionally used by the right-hand or left-hand users.

It is another object of the present invention to provide a punching apparatus compact to be packed and easy to be assembled.

In accordance with a first aspect of the present invention, there is provided a handle device for use in a punching apparatus. The handle device comprises an elongated link and a handle member. The elongated link is used for coupling to a punching structure of the punching apparatus. The elongated link has first and second ends, wherein the cross sections of the first and the second ends are substantially identical to each other in shape and size. The handle member is used for receiving an external force. The handle member has a third end. The cross section of the third end conforms to both of the cross sections of the first and the second ends in order that the handle member is engageable with the elongated link at any of the first and the second ends, thereby transmitting the elongated link to move in response to the external force so as to actuate the punching structure.

In an embodiment, the elongated link is prism-shaped.

In an embodiment, the elongated link is a hexagonal prism, and each of the first, the second and the third end cross sections is hexagon-shaped.

In an embodiment, the cross sections of the first and the second ends are solid, the cross section of the third end is hollow, and the third end is sleeved on either of the first and the second ends to engage the handle member with the elongated link in the operational mode.

In an embodiment, the cross sections of the first and the second ends are hollow, the cross section of the third end is solid, and the third end is sleeved by either of the first and the second ends to engage the handle member with the elongated link in the operational mode.

In accordance with a second aspect of the present invention, there is provided a punching apparatus. The punching apparatus comprises a base, a punching structure, a transmitting shaft and a first handle member. The base is used for placing thereon an object to be punched. The punching structure is mounted over the base for digging into the object to create at least one hole. The transmitting shaft is coupled to the punching structure and rotated to actuate the punching structure to move between a punching position and a releasing position in response to first and second external forces, respectively. The first handle member is attachable to and detachable from any of a first end and a second end of the transmitting shaft, and transmits the punching structure to move between the punching position and the releasing position in response to the first and the second external forces exerted thereon, respectively.

In an embodiment, the first and the second ends of the transmitting shaft are hexagonal posts.

In an embodiment, the first handle member has a hollow hexagonal end for optionally and selectively engaging with one of the first and the second hexagonal posts.

In an embodiment, the punching apparatus further comprises a positioning pin for penetrating a hole on the first handle member and a hole on the transmitting shaft in order to secure the first handle member to a selected one of the first and the second ends of the transmitting shaft.

In an embodiment, the punching apparatus further comprises a stopper attachable to and detachable from any of the first and the second ends of the transmitting shaft for preventing from dislocation of the transmitting shaft, wherein the stopper and the first handle member are exchangeably disposed at the first and the second ends of the transmitting shaft.

In an embodiment, the first and the second ends of the transmitting shaft are hexagonal posts, and the first handle member and the stopper have respective hollow hexagonal ends for engaging with the first and the second hexagonal posts.

In an embodiment, the punching apparatus further comprises a positioning pin for penetrating a hole on the stopper and a hole on the transmitting shaft in order to secure the stopper to a selected one of the first and the second ends of the transmitting shaft.

In an embodiment, the punching apparatus further comprises a casing for sheltering the punching structure and the transmitting shaft.

In an embodiment, the object is a stack of paper sheets.

In an embodiment, the first and the second external forces are exerted to pivot the first handle member in different directions.

In an embodiment, the punching apparatus further comprises a second handle member attachable to and detachable from any of the first and the second ends of the transmitting shaft, wherein the first and the second handle members are exchangeably disposed at the first and the second ends of the transmitting shaft.

In an embodiment, the first and the second ends of the transmitting shaft are hexagonal posts, and the first and the second handle members have respective hollow hexagonal ends for engaging with the first and the second hexagonal posts.

In an embodiment, the punching apparatus further comprises a positioning pin for penetrating a hole on the second handle member and a hole on the transmitting shaft in order to secure the second handle member to a selected one of the first and the second ends of the transmitting shaft.

In accordance with a third aspect of the present invention, there is provided a punching apparatus. The punching apparatus comprises a base, a transmitting shaft, first and second handle members and a punching structure. The base is sued for placing thereon an object to be punched. The transmitting shaft is disposed over the base. The first and the second handle members detachably are coupled to first and second ends of the transmitting shaft, respectively. The punching structure is coupled to the transmitting shaft for digging holes on the object in response to an external force exerted on one or both of the first and the second handle members.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic diagram illustrating a conventional punching apparatus suitable for right-hand users;

FIG. 1(b) is a schematic diagram illustrating a conventional punching apparatus suitable for left-hand users;

FIG. 2(a) is a schematic diagram illustrating a conventional punching apparatus suitable for both right-hand and left-hand users;

FIG. 2(b) is a schematic diagram illustrating another conventional punching apparatus suitable for both right-hand and left-hand users;

FIG. 3(a) is a resolving diagram illustrating a punching apparatus having a detachable handle according to a preferred embodiment of the present invention;

FIG. 3(b) is a partially enlarged view of the handle portion of FIG. 3(a) cooperating with the associated parts to work;

FIG. 3(c) is a schematic diagram showing an alternative handle device for use in the punching apparatus of FIG. 3(a);

FIGS. 4(a) and 4(b) are schematic diagrams showing two assembled configurations of the punching apparatus in FIG. 3(a) suitable for right-hand and left-hand users, respectively; and

FIG. 5 is a schematic diagram illustrating a punching apparatus having two handles suitable for both right-hand and left-hand users, which are detachable for storage or package, according to another embodiment of the present invention.

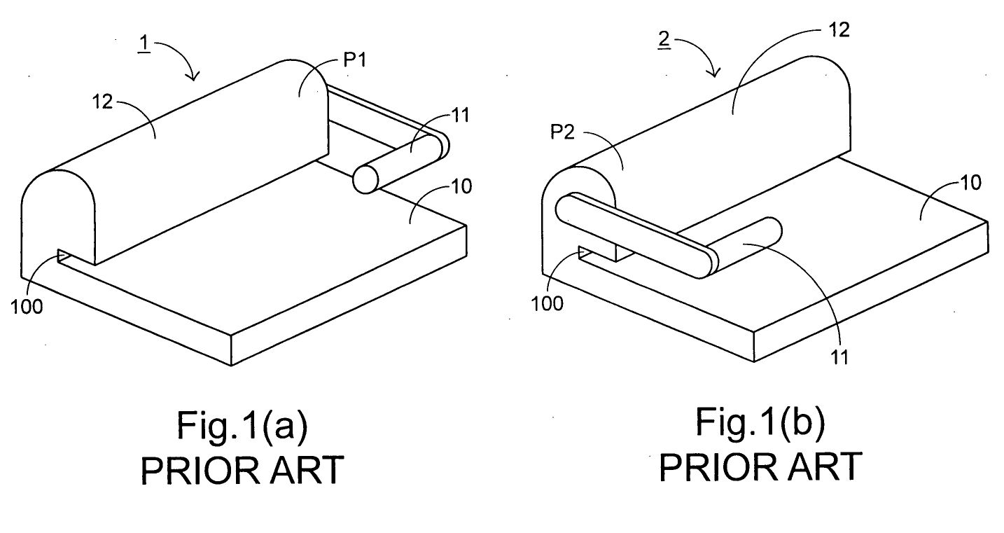

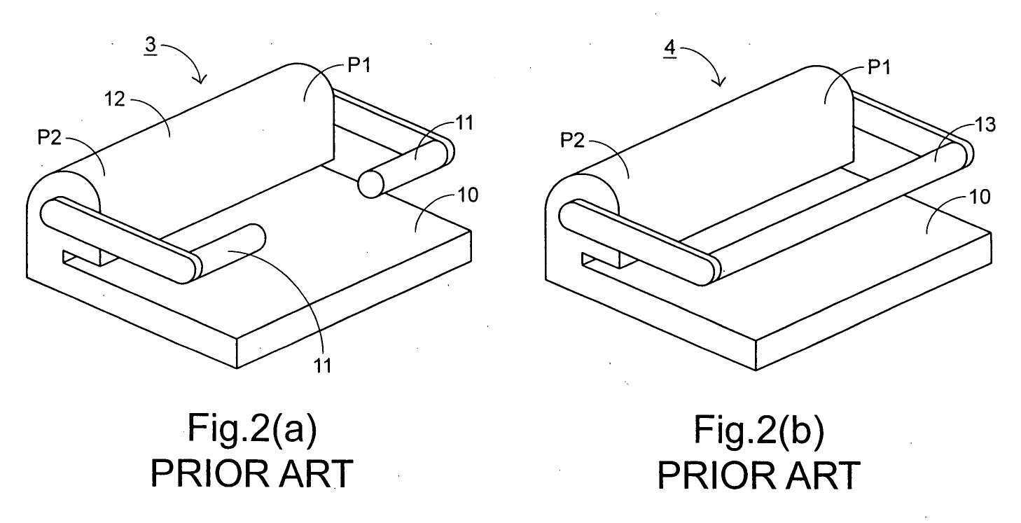

### DETAILED DESCRIPTION OF THE PREFERRED EMBODIMENT

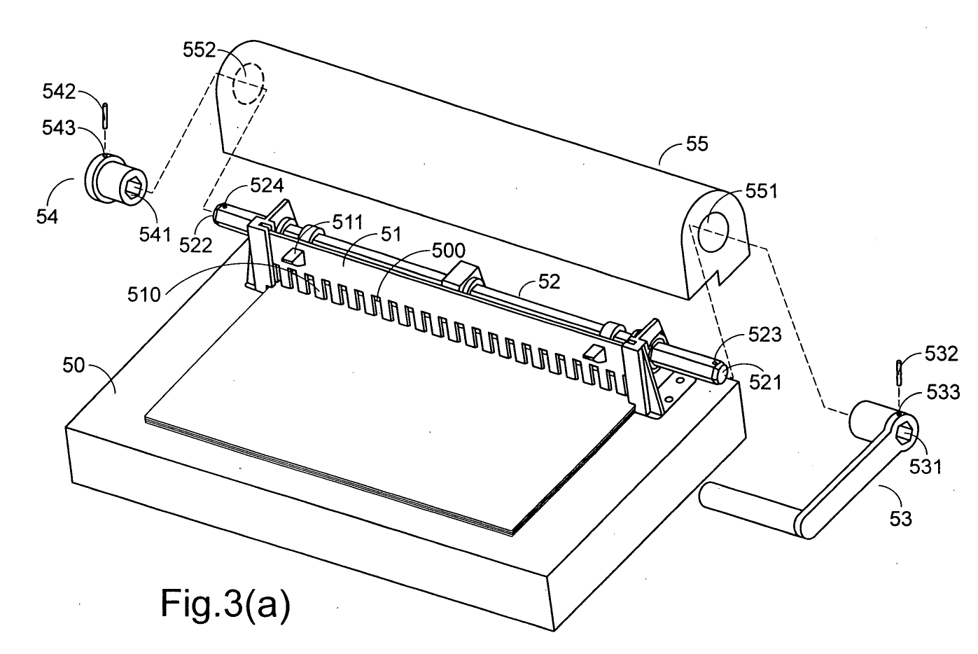

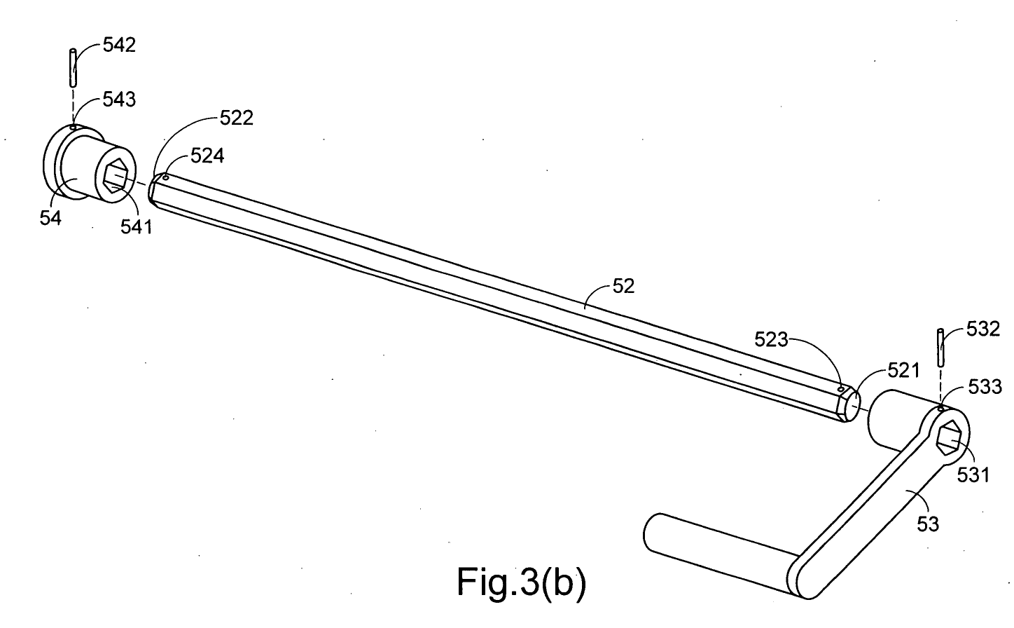

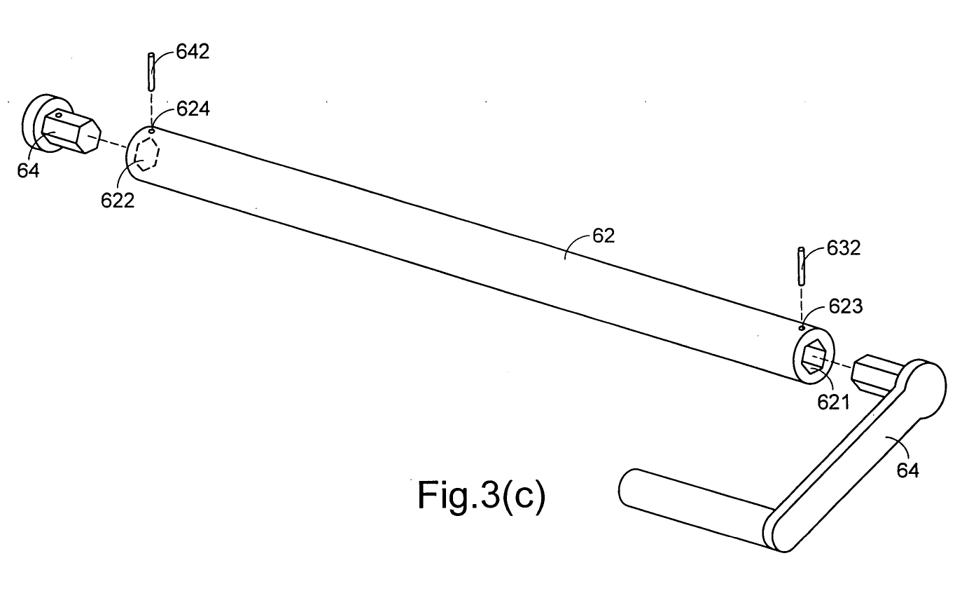

Referring to FIG. 3(a), a punching apparatus according to a preferred embodiment of the present invention is shown. The punching apparatus 5 comprises a base 50, a punching structure 51, a transmitting shaft 52, a handle member 53, a stopper 54 and a casing 55. The punching structure 51 is disposed on the base 50 and covered by the casing 55. The punching structure 51 comprises a series of punchers 510 for digging into paper placed on the base 50 to create a series of holes on paper. Via a connecting member 511, the transmitting shaft 52 is coupled to the punching structure 51. In response to the rotation of the transmitting shaft 52, the punchers 510 are moved downwards or upwards to switch between a punching position and a releasing position. The handle member 53 is attachable to and detachable from the transmitting shaft 52. In response to the user's pushing force exerted on the handle member 53, the transmitting shaft 52 is rotated to actuate the punching structure 51 to move to the punching position so as to dig into the paper sheets to create a corresponding number of through holes. Whereas, in response to the release of the pushing force or the user's upward releasing force exerted on the handle member 53, the transmitting shaft 52 rotates and transmits the punching structure 51 back to the releasing position. The stopper 54 is attachable to the end of the transmitting shaft 52 opposite to the handle member 53 for preventing from dislocation of the transmitting shaft 52.

The enlarged view of the engagement manner of the transmitting shaft 52 with the handle member 53 and the stopper 54 is shown in FIG. 3(b). As shown, both ends of the link, i.e. the transmitting shaft 52, are shaped as hexagonal posts 521 and 522, which are identical to each other in shape and size. The handle member 53 and the stopper 54 have hollow hexagonal ends 531 and 541 of the same shape and size for engaging with the hexagonal posts 521 and 522. Because of the identity of the hexagonal post 521 to the hexagonal post 522, and the identity of the hollow hexagonal end 531 to the hollow hexagonal end 541, the handle member 53 can exchange with the stopper 54 to be positioned at either side of the transmitting shaft 52 depending on users' requirement.

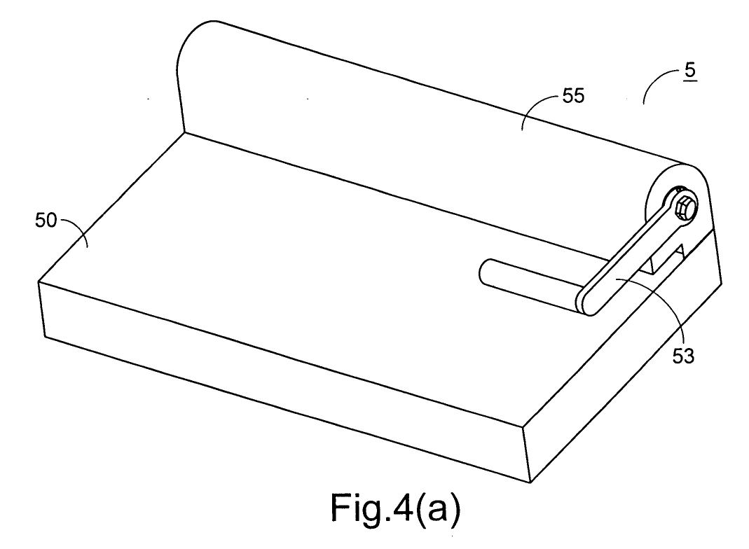

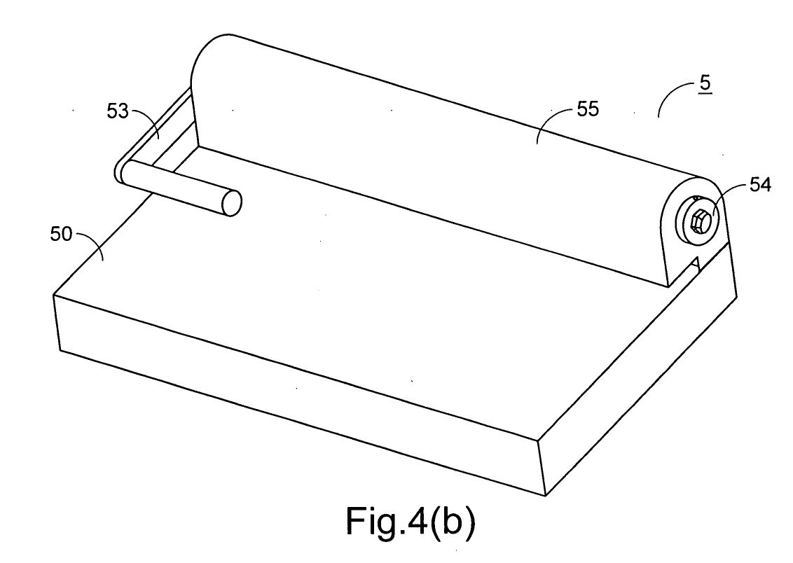

The use of the present punching apparatus will be described hereinafter. The casing 55 sheltering the punching structure 51 and the transmitting shaft 52 has two openings 551 and 552 at opposite ends. The hollow hexagonal end 531 of the handle member 53 penetrates the opening 551 and engages with the hexagonal post 521 of the transmitting shaft 52. Then, a positioning pin 532 is inserted into a hole 533 on the handle member 53 and a hole 523 on the transmitting shaft 52 to secure the handle member 53 to the transmitting shaft 52. For a purpose of preventing from dislocation of the transmitting shaft 52, the hollow hexagonal end 541 of the stopper 54 penetrates the opening 552 and engages with the hexagonal post 522 of the transmitting shaft 52. Likewise, a positioning pin 542 is inserted into a hole 543 on the stopper 54 and a hole 524 on the transmitting shaft 52 to secure the stopper 54 to the opposite end of the transmitting shaft 52. The assembled structure is schematically shown in FIG. 4(a). For punching holes, the paper sheets (not shown) are firstly placed on a top surface of the base 50 with a front thereof sustaining against the alignment wall 500 behind the punchers 510. The pushing force applied onto the handle member 53 transmits the plurality of punchers 511 to move downward via the coupling member 511, and the punchers 511 dig into the paper sheets to create holes on the paper sheets.

The punching apparatus illustrated as above is suitable for right-hand users. The same punching apparatus can also be suitable for left-hand users by exchanging positions of the stopper 54 and the handle member 53 attached to the opposite ends of the transmitting shaft 52. First of all, the pins 532 and 542 are detached from associated holes to release the handle member 53 and the stopper 54 from the transmitting shaft 52. Then, the handle member 53 and the stopper 54 are pulled out of the hexagonal posts 521 and 522, respectively, and re-attached to the hexagonal posts 522 and 521, respectively, in a manner described above. The assembled punching apparatus is as shown in FIG. 4(b).

Since the handle member 53 can be arbitrarily disposed at either of the right and the left ends of the transmitting shaft 52, both of the right-hand users and left-hand users can be satisfied with the inclusion of a single handle member. Furthermore, the handle member 53 and the stopper 54 can be detached from the transmitting shaft 52 so as to save space for packing the punching apparatus 5.

In the above embodiment, the transmitting shaft 52 has two hexagonal posts 521 and 522 at opposite ends thereof, and the handle member 53 and the stopper 54 have hollow hexagonal ends 531 and 541, respectively, for engagement of the handle member 53 and the stopper 54 with the transmitting shaft 52. Alternatively, the transmitting shaft can be a hollow hexagonal tube 62 having opposite hollow hexagonal ends 621 and 622, as shown in FIG. 3(c), for receiving therein respective hexagonal posts 631 and 641 of a handle member 63 and a stopper 64. The elements, likewise, are secured with pins 632 and 642.

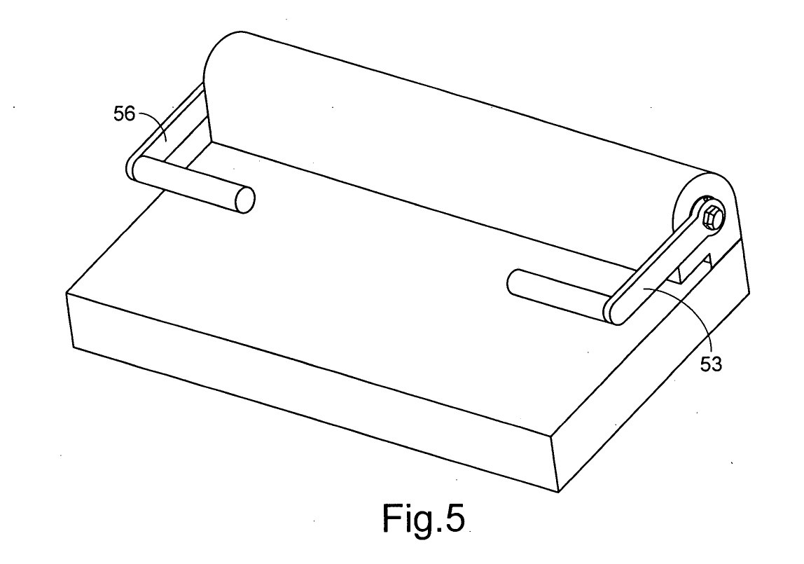

A further embodiment of a punching apparatus is illustrated in FIG. 5. In this embodiment, the structure of the punching apparatus 5 is similar to that of FIG. 3(a), except that the stopper 54 is replaced by an additional handle member 56. The dual handles allow both right-hand and left-hand users to selectively manipulate. The engaging manner of the handle members 53 and 56 with the transmitting shaft 52 are similar to that shown in FIG. 3(b) or 3(c). In other words, the handle members 53 and 56 can be easily attached to or detached from the transmitting shaft 52. Since the handle members 53 and 56 can be detached from the transmitting shaft 52, the space for packing the punching apparatus 6 is effectively saved.

It is understood that by improving the structure of the handle to be detachable from the transmitting shaft, the punching apparatus can be made flexible in use for both right-hand and left-hand users. Moreover, the detachable feature of the handle(s) facilitates the storage or package of the punching apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A handle device for use in a punching apparatus, comprising:
an elongated link for coupling to a punching structure of said punching apparatus, said elongated link having first and second ends, the cross sections of said first and said second ends being substantially identical to each other in shape and size; and
a handle member for receiving an external force, said handle member having a third end, the cross section of said third end conforming to both of said cross sections of said first and said second ends in order that said handle member is engageable with said elongated link at any of said first and said second ends, thereby transmitting said elongated link to move in response to said external force so as to actuate said punching structure.

2. The handle device according to claim 1 wherein said elongated link is prism-shaped.

3. The handle device according to claim 2 wherein said elongated link is a hexagonal prism, and each of said first, said second and said third end cross sections is hexagon-shaped.

4. The handle device according to claim 1 wherein said cross sections of said first and said second ends are solid, said cross section of said third end is hollow, and said third end is sleeved on either of said first and said second ends to engage said handle member with said elongated link in said operational mode.

5. The handle device according to claim 1 wherein said cross sections of said first and said second ends are hollow, said cross section of said third end is solid, and said third end is sleeved by either of said first and said second ends to engage said handle member with said elongated link in said operational mode.
